(19) United States
(12) Patent Application Publication
(10) Pub. No.: US 2023/0297911 A1
(43) Pub. Date: Sep. 21, 2023

(54) AUTOMATED CONSTRUCTION MATERIALS MANAGEMENT PLATFORM

(71) Applicant: LEMOS, LLC, Seattle, WA (US)

(72) Inventors: Peter WOLFF, Seattle, WA (US); Hill PIERCE, Seattle, WA (US); Cesar TOLENTINO, Seattle, WA (US); Kieran JENDRO, Seattle, WA (US)

(21) Appl. No.: 18/183,842

(22) Filed: Mar. 14, 2023

Related U.S. Application Data
(60) Provisional application No. 63/319,871, filed on Mar. 15, 2022.

(51) Int. Cl. G06Q 10/0631; G06Q 10/10; G06Q 50/16; G06F 30/13

(52) U.S. Cl. CPC G06Q 10/06313; G06Q 10/103; G06Q 50/165; G06F 30/13; G06F 2111/18

(57) ABSTRACT

Methods for automatically processing, preparing, and managing a component analysis of a building from a BIM application are disclosed. In embodiments, a 3D model isolated from its surroundings is provided to a system for processing a rules engine to tag duplicate components, normalize component data, and extract relevant components for estimation. Some embodiments may employ machine learning to improve the accuracy and efficiency of the rules engine. The tagged, normalized, and extracted components can then be visualized and analyzed via a user interface. In some embodiments, the components can be exported for further processing and/or preparation into a presentation format. Other embodiments may be described and/or claimed.

### CROSS-REFERENCE TO RELATED APPLICATIONS

This application claims priority to U.S. Provisional Application No. 63/319,871, filed on 15 Mar. 2022, the contents of which are incorporated into this application by this reference as if fully stated herein.

### TECHNICAL FIELD

Disclosed embodiments are directed to software to assist in the construction of buildings and other structures, and in particular, to software platforms that provide analysis of a building design or model for determining the cost and/or quantity of materials needed to construct the building, as well as providing tools for visualization of quantities and comparisons against other projects.

### BACKGROUND

Real estate development, such as erecting a building, is a relatively complex endeavor involving a number of different parties: the property owner; the developer, who may be the property owner or may be in contract with the owner to develop the owner's property; the architectural firm, who works with the owner and developer to design a building or buildings to meet the vision of the owner and developer; the general contractor, who may also be or be part of the developer, who is responsible for executing building construction; and various subcontractors who are coordinated by the general contractor and who carry out the actual construction work. In the course of development, all these various parties typically must coordinate efforts to see a development project to completion.

Similar to most industries, real estate development is increasingly aided with computers. Building information and modeling (BIM) software can be used by architects and designers to create the plans for a structure to be constructed. Such software can allow the structure to be modeled as a 3D model. The software further allows the 3D model to be reduced to a series of 2D views, similar to blueprints that would previously have been drafted by hand. BIM software can generate these 2D views or plans as the 3D model can include necessary structural information such as framing, placement of doors, windows, etc., roof line configurations, and other aspects of the building that are important to the construction process.

The background description provided herein is for the purpose of generally presenting the context of the disclosure. Unless otherwise indicated herein, the materials described in this section are not prior art to the claims in this application and are not admitted to be prior art by inclusion in this section.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates an example method for the processing of data from a 3D building or architectural model, and using the data to generate a materials quantity analysis for constructing the building, according to various embodiments.

FIG. 2 depicts an example process flow proceeding from a 3D rendering of a development similar to what would be produced in BIM software to a materials quantity report, that may result from the example method of FIG. 1, according to various embodiments.

FIG. 3 is a block diagram of an example system that may implement the example method of FIG. 1 or the process flows of FIGS. 2 and/or 3, according to various embodiments.

FIG. 4 is a flow diagram of the import and rules engine employed with the method of FIG. 1, in a platform context, to process data from a 3D building or architectural model, according to various embodiments.

FIG. 5A depicts a first screen of an example interface for interaction with data from a 3D building model that has been processed according to the example method of FIG. 1, according to various embodiments.

FIG. 5B depicts a second screen of the example interface of FIG. 5A, illustrating an embedded 3D viewer, according to various embodiments.

FIG. 5C depicts a third screen of the example interface of FIG. 5A, illustrating graphical elements for visualizing the data, according to various embodiments.

FIG. 6 is a block diagram of an example computer that can be used to implement some or all of the components of the disclosed systems and methods, according to various embodiments.

FIG. 7 is a block diagram of a computer-readable storage medium that can be used to implement some of the components of the system or methods disclosed herein, according to various embodiments.

### DETAILED DESCRIPTION

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Aspects of the disclosure are disclosed in the accompanying description. Alternate embodiments of the present disclosure and their equivalents may be devised without parting from the spirit or scope of the present disclosure. It should be noted that like elements disclosed below are indicated by like reference numbers in the drawings.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

Contracting for real estate development is risky because numerous factors that impact on cost remain speculative or unknown well into the development process. The involvement of multiple parties and vendors in a typical construction or development project contributes to these unknown cost impacts, especially because not all parties are involved in a development project at the same time. Architects and planners are typically involved from initial planning stages and throughout the lifetime of a project. Contractors and subcontractors may be engaged initially in an advisory capacity, and are fully engaged once development plans have been mostly finalized.

The different times at which planners and builders, including general and subcontractors, are engaged by a developer often causes an information disconnect between these parties, and as a result construction costs remain unknown until late in the development process. Further, the various parties may differ in terminology and how they discuss various aspects of the project, e.g. lack of common language, measurement, and coordination, which further exacerbates the information disconnect. Architects and engineers do not have the tools to know how their documents and any changes thereto influence cost. Contractors, in turn, spend significant effort accounting for, or looking back on, what the owner and architect have already done or decided, when their expertise could benefit costing during the design process.

At least because of these reasons, budgeting and underwriting a building or development involves an array of contingencies, which can result in a substantial spread in bids for a given project. This substantial spread can further frustrate the effort of general contractor selection by the developer, and/or subcontractor selection by the general contractor, as while budget considerations may limit selection of the more expensive bids, low bids may be due to contractor underestimation and can result in cost escalations to see the project completed.

Furthermore, the communications disconnect gives rise to opacity and uncertainty, which are obstacles to obtaining a realistic assessment of construction requirements such as materials, labor, etc. At present, building projects are typically analyzed using paper or digital copies of a building model which may be generated from a 3D model, which must then be analyzed by hand to generate a quote. Some software tools exist that can assist with the analysis process; however, these tools are not automatic, and still require relatively sophisticated knowledge to use effectively, essentially just automating the hand process. These tools further may require an experienced user to manipulate the 3D model(s) to fully determine all constituent building components. For accuracy, these paper or digital copies must have enough different views that all relevant parts of the building structure can be visualized and analyzed. This data initially exists in building plans/models within CAD software in raw form, but because of different ways that architects can utilize CAD tools, can result in analyses that are unacceptably inaccurate.

It is typically the general contractor, possibly in conjunction with one or more key subcontractors, that generates the materials quantification and/or cost estimate from the building plans. The developer may provide a number of different general contractors with copies of the plans to obtain a number of competitive bids. Each contractor is usually opaque with how they analyze the plans to arrive at a bid number, as well as where the contractor and/or subcontractor includes contingencies to account for possible change orders due to design modifications. A wide spread between high and low bids may be inexplicable without insight into how the contractors each derived their materials quantities, which in turn factors into their estimates. If a particular design is left open, e.g. subject to possible changes, design changes made during construction, a contractor may recognize the possibility of further changes and either provide a range of prices for a quote or, for example if ranges are not allowed, may simply increase the bid estimate to anticipate possible changes.

Current methods of estimating building or structure construction costs typically involve providing a general contractor with copies of the building plans, e.g. blueprints, that show the various components and dimensions of the building. The contractor can then analyze the plans to determine the various constituent components, including the scope of various trade work such as heating-ventilation-air conditioning (HVAC), plumbing, and electric. With this information, the contractor can determine material costs, labor costs, and obtain quotes from the appropriate subcontractors. The final quote will depend heavily upon how the contractor analyzes the scope of work. If the contractor is insufficiently thorough or misses some critical components, the final quote may be inaccurate. Further, this inaccuracy may not be discovered until after construction is commenced, when the contractor may either have to take a loss, or approach the developer to increase the bid.

Some development projects may also utilize change orders to address design changes sought to be implemented while a project is under construction. As the project is under construction, the contractor typically cannot be changed, and so the developer may somewhat be at the mercy of the contractor if a given change order will significantly impact construction costs. The developer may further be unable to determine how much a given change order will impact the costs until the contractor reviews the proposed changes. As a result, change orders may result in an iterative process between the developer and the contractor if a particular change is out of budget and must be adjusted. This process may be time consuming, and depending on when in the construction process a particular change order is considered, may necessitate work stoppage until a change order can be resolved. This can lead to project delays.

A developer, architect, designer, and/or property owner typically lacks the necessary experience and knowledge to accurately assess the materials requirements and estimate a construction project, and so must rely upon a contractor's estimation skills. If multiple contractors are bidding on a project, determining whether a particular contractor's bid is reasonable may be difficult or impossible for the developer to ascertain. Contractors are typically not motivated to share their estimation strategy, as a degree of opacity can insulate them from a developer who may otherwise wish to micromanage the contractor's pricing.

Consequently, there is a need for a tool that can allow a person who is not skilled in project estimation, such as a developer or land owner, to obtain a reasonable quantification of materials needed to construct a given building or structure in an automatic fashion, without having to rely upon a contractor or other skilled estimator. Furthermore, there is a need for a tool that can rapidly provide revised quantifications and/or estimates as a building design is modified, to gain insight into how a proposed change is likely to impact construction costs.

Disclosed embodiments are directed to a software or software/hardware platform that include systems and methods for automatically analyzing a structure or building to be constructed from a 3D model, which may be provided by BIM software. The disclosed embodiments can take the 3D model and analyze it to determine its constituent parts, e.g. structural members, fixtures, cabinetry, finishes, doors, windows, mechanical systems, plumbing, electrical, etc. In one possible embodiment, a software application is provided that works within a BIM ecosystem, receiving and/or querying a BIM or computer-aided design (CAD) program, extracting information about a structure from the BIM or CAD program, processing the information, and translating that information into industry-standard formats that are used by contractors for generating materials lists and cost estimates.

Depending on the specifics of a given implementation, a user may not need to directly interact with the 3D model within the BIM or CAD program to obtain a materials list and quantities. Rather, the software application can automatically obtain the necessary information from the BIM or CAD program. Further, disclosed embodiments include an example interface that can provide a 2D or 3D view of the model, apart from a CAD program. The interface may allow the user to select one or more items from a materials list generated from the BIM or CAD program information, and then indicate on the model displayed in the software application where the selected items are located. Still further, in some embodiments, the user may be able to select one or more items on the model and have the items' corresponding entries in the materials list highlighted. In some embodiments, a machine learning algorithm may be employed to predict some of these selections, saving the user time and effort. In some embodiments, the interface and/or model viewer may be implemented using a web browser. In other embodiments, the interface and/or model viewer may be implemented using a dedicated interface or application. In still other embodiments, a hybrid approach of web and dedicated application may be used.

The interface of a software application according to disclosed embodiments, by providing a list or comparable display of materials, can enable a user to audit/adjust quantities, costs, and/or any other relevant data points, depending upon the specifics of a given implementation. With the type and quantity of constituent parts determined, the structure or building can be automatically analyzed using industry-standard rates. In some possible embodiments, the analysis may also be used to estimate project costs, such as by incorporating known materials costs and average labor time and costs. Furthermore, because of the automated nature of the disclosed systems and methods, changed buildings or structures can be relatively quickly re-analyzed and/or re-estimated, to gain insight into how design changes may impact construction costs. Disclosed embodiments may further allow for comparisons with other comparable buildings, previous design iterations of the current building, and/or any other data points that may be provided to an embodiment system, depending upon the specifics of a given implementation.

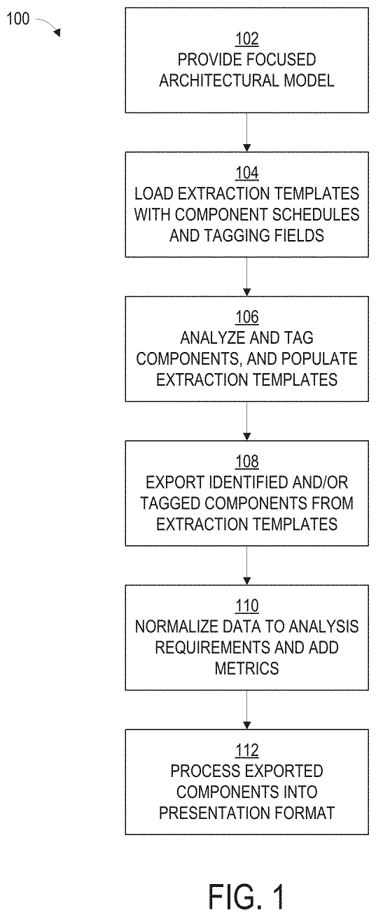

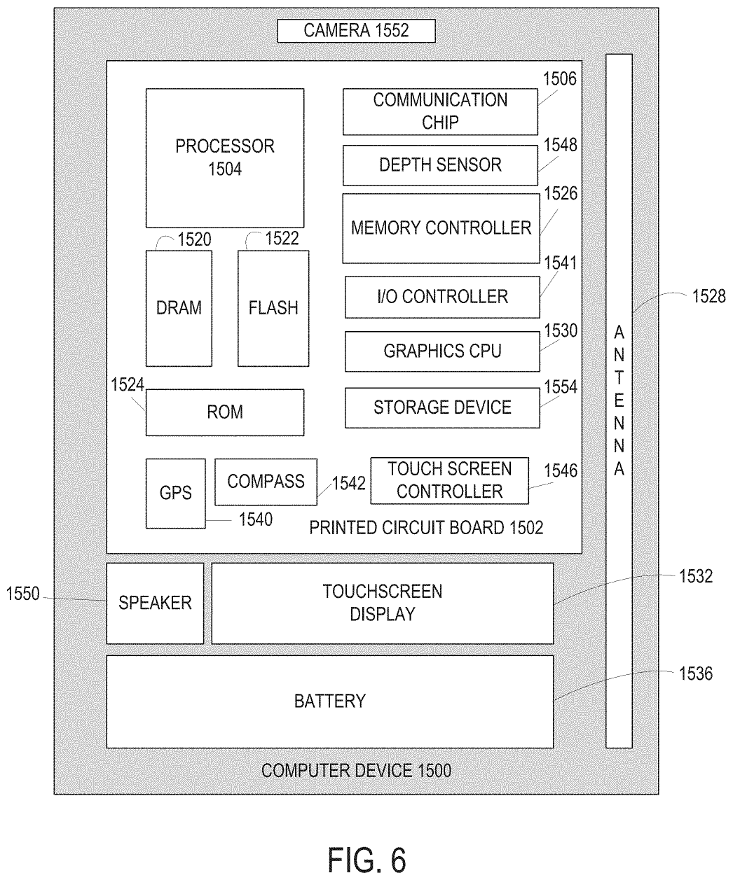

FIG. 1 illustrates the operations of an example method 100 that may be used to generate a materials analysis of a construction project from a 3D model of a building or other structure. In various embodiments, method 100 may be performed on a computer device, such as computer device 1500 described below with respect to FIG. 6. The various operations of method 100 may be performed in whole or in part, and in order or out of order, depending upon the specifics of a given implementation. Furthermore, in some embodiments operations may be added, modified, or removed. In embodiments, method 100 may be carried out by a software platform, which may be comprised of one or more software applications. In some embodiments, at least part of method 100 may be implemented using software, hardware, or a combination of both. The software platform may, in embodiments, be implemented on one or more remote servers or a cloud service, and may be provided using a software as a server (SaaS) model.

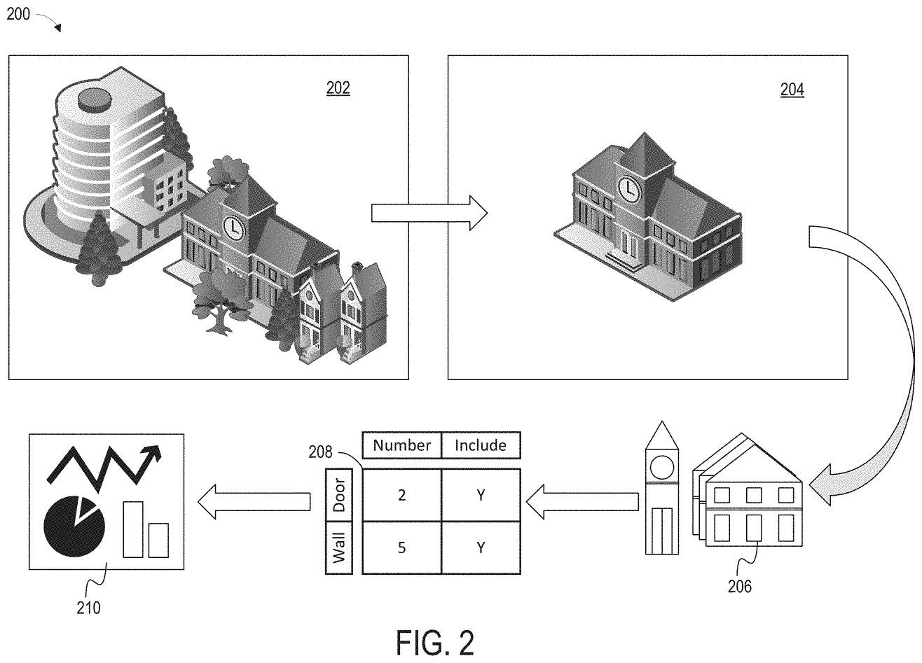

In operation 102 of embodiments, a focused architectural model is provided from a filtered 3D view, which may be generated using a BIM application. The initial 3D view, as will be discussed below with respect to FIG. 2, may include a variety of features such as landscaping, roads, parks, multiple buildings, background imagery, etc., which are irrelevant to analysis of the building of interest that is to be constructed. In embodiments where the building of interest cannot be readily marked or logically separated from extraneous features, the presence of these extraneous structures and features could throw off the materials quantity analysis by introducing elements that are not part of the building of interest. For example, if a given 3D view includes multiple buildings, the analysis process may attempt to analyze and count the components of all buildings present without distinction. Accordingly, generating from the initial 3D view a focused architectural model that includes only the building of interest without any surrounding context allows for an accurate estimation by only analyzing relevant components.

In other embodiments, depending upon the implementation of the 3D view and/or the BIM software or other software used to generate the 3D view, it may be possible to flag or otherwise designate a given building or structure for analysis while leaving other extraneous features in place. The analysis process may then be able to isolate the relevant building or structure and its associated components based on the flag or designation. In still other embodiments, depending upon the structure of the model and nature of any surrounding extraneous features, it may be possible for the software to automatically identify and isolate the structure to be analyzed.

In various embodiments, the focused architectural model may be in a Revit (.rvt) format, used by Autodesk® Revit® software. However, other suitable embodiments may be employed, e.g. .dwg or .ifc, or any other suitable file format that includes component-level details of the structure or building design to be estimated. For accurate analysis, in embodiments the focused architectural model information should include components such as walls, floors, ceilings, roofs, foundations, windows, doors, and any other building feature. These components may further break down into sub components, such as framing, insulation, siding, roofing, flooring, finishes, trim, etc. Additionally, the information may include electrical specifications such as lights, switches, outlets, breaker panels, appliances, etc., plumbing specifications such as faucets, sinks, toilets, showers, tubs, water heaters, gas lines, etc., HVAC specifications such as registers, returns, radiators, baseboard heaters, radiant floors, air conditioning units, furnaces, air handlers, air exchanges, etc., and/or any additional components or other building information that would impact on construction estimates. In some embodiments, some of this information could be supplied based on industry practice and building codes, such as required insulation thickness, hardware, connectors, etc. In such embodiments, the building information may not need to include such component information.

In operation 104, once a focused architectural model is provided, one or more classification algorithms (which may comprise or be used by a “rules engine”), that may be pre-loaded and managed within an implementing software application, are applied to data in the model, in various embodiments. Depending on the specifics of a given embodiment, the classification algorithm(s) and/or associated rules engine may be provided as part of the BIM software that provides the focused architectural model, as part of a software application implementing the processing of this disclosure, and/or as part of a stand-alone processor or preprocessor module or software component. A machine learning (ML) algorithm may be employed in some embodiments to serve as, implement, and/or enhance the classification algorithms.

The classification algorithms may include various schedules, such as extraction templates that are part of or work with the classification algorithms in some embodiments, which allow the data of the focused architectural model to be analyzed, tagged, and extracted. More specifically, these algorithms provide a framework from which inconsistently modeled and labeled elements of the building can be identified and normalized, e.g., given consistent labeling. For instance, designers may not rigorously or consistently tag exterior walls and/or doors. Such inconsistency can complicate component analysis by requiring an understanding of a particular designer's habits to identify accurately components relevant to materials quantification and/or estimation. Previously, a degree of human interaction with the model to overcome these inconsistencies was necessitated. In disclosed embodiments, the algorithms (and associated templates, if any) provide a framework for identification of data about walls, doors, windows, and other building components in a design in a consistent fashion. Once identified, the data can be normalized and extracted. This normalized extracted data can then be processed using the classification algorithms, and forms the basis for quantification and/or estimation in subsequent operations. In addition, the normalized data enables functionality of the communication and analysis tools presented herein.

The schedules of the normalized and extracted data generated by the application, platform, user, or any and all of these, may include various categories such as families (e.g. structural, plumbing, electrical, etc.), materials (e.g. lumber, panels, siding, flooring, roofing, etc.), and project information and/or project metrics (e.g. any data that would impact on pricing such as specialty materials, location, other data relevant to analysis such as gross square footage, number of floors, etc.). More or fewer schedules may be employed depending upon the specifics of a given embodiment, and the intended analysis. The data generated by the application, platform, user, or any and all of these, may further include one or more custom tags or parameters, which may be part of one or more of the data schedules, used for various purposes, such as de-duplicating data, excluding or including items in the architectural model for analysis, tags for custom parameters useful in subsequent analysis, and any other purposes that may later be developed. The data may be in any suitable format for the software used for extraction. For example, Revit® uses a .rvt format; other software may use different export formats.

In operation 106, the normalized and extracted data is analyzed and processed to remove duplicate data and irrelevant data, and to identify data that is needed to create an estimate. The analysis may include such functions as identifying and tagging interior walls, exterior walls, floors, computing gross square footage, and other processing necessary to provide a desired analysis, according to the needs of a given implementation. The focused architectural model may have duplicate data in the form of components and families. For example, a wall may include a door as a specific component, and the door in turn may be comprised of various additional components such as a panel, one or more windows, hinges, and a jamb. Thus, the door effectively shows up twice in the model data, once as the specific component, and then again as the collection of its constituent components. In such an example, the constituent components would not need to be counted, as the analysis would only need to consider the door as a specific component, and adding the constituent components would result in an inaccurate materials quantity. Consequently, the constituent components would be tagged as sub-components allowing the data to be parsed and de-duplicated. Other examples of potential duplicate data may include siding where an architect has experimented with different siding types. The BIM software may allow multiple siding types to be applied on top of each other, e.g. shake siding, fiber cement siding, etc., for sake of viewing the model. When exposed in the normalized and extracted data and viewed in the software application, the multiple siding types would appear, whereas only one type would actually be installed. The extraneous siding types are accordingly tagged as secondary allowing the data to be parsed in subsequent steps.

Analysis of the objects may also, in embodiments, include tagging items for inclusion and appending data like the word “Exterior” for walls that are on the exterior of the building and “Interior” for walls that are within the building, thereby allowing the system to check data that may be inconsistently applied by BIM modelers. Analysis may further include independently calculating gross square footage, number of floors, and any other project parameters that may not be consistently calculated by various designers, but are necessary for generating a materials quantity and/or cost estimate. As part of analysis and tagging, the normalized and extracted data is populated with the various components, tags, parameters, and other relevant information resulting from analysis of the focused architectural model. This normalized and extracted data, as discussed above, eliminates inconsistencies that may arise between different designers and instead provides the analysis and tagging results in a consistent and normalized fashion that enables subsequent processing of the analysis into a consistent format.

Processing for identification, analysis, and tagging may be performed using any suitable technique. In various embodiments, such as implementations that use Revit® software, a Dynamo™ script or scripts may perform the analysis, deduplication, and tagging of information from the focused architectural model, and population of the schedules. However, other programming and/or scripting techniques may be employed, depending upon the type of software used with the focused architectural model.

Following identification, analysis, and tagging, in operation 108 the extracted and identified and/or tagged components are exported for further processing, in various embodiments. The data may be exported to a suitable format, such as a comma-separated value (CSV) file and/or another appropriate format, which may then be imported into a spreadsheet program, such as Microsoft® Excel®. However, any suitable format may be employed, depending upon how subsequent processing is to be carried out, e.g. what sort of software is used for subsequent processing.

In operation 110, the extracted and exported data is translated using the classification algorithms described above, from BIM software generated quantities in the original architectural model data into specific categories, which may be familiar to owners and contractors. The consistent application of these classification systems results in data that allows unique communication and analysis as presented herein. In embodiments, this translation is not a direct 1:1 relationship of one set of quantities to the other and may depend upon the particular output format for the analysis, as will be discussed below. For instance, an “interior wall” in a BIM model may actually be an “Interior Partition” or a “Wall Finish” in UniFormat. The acronym “GWB” may refer to interior gypsum board in Div 9 of MasterFormat or Exterior Sheathing in Div 6 of MasterFormat. The classification algorithm(s) may include specific fields that facilitate this translation, with initial processing in operation 106 allowing for normalization of terms, and subsequent processing in operation 110 translating the normalized terms into data for presentation, according to embodiments. In some embodiments, additional metrics may be computed from the extracted data, depending upon the needs of a given implementation. For example, cubic yards of concrete per square foot of building may be estimated, even if not otherwise present in the focused architectural model. Other metrics that may be useful for providing a comparison with other building projects may be computed from the extracted and exported data. Processing also may include removing any items that are tagged to be ignored, such as resulting from operation 106.

In operation 112, in embodiments, the resulting normalized, de-duplicated, and tagged extracted data from the architectural model is processed and analyzed to generate a materials quantity and/or cost estimate. The analysis may be presented in an industry-standard format, such as UniFormat or MasterFormat, and/or in another suitable format. The reports may optionally include any branding, and multiple formats may be generated and combined into a single report, such as with multiple sheets or tabs. For example, one tab may provide the analysis in UniFormat, and a second tab may provide the same analysis in MasterFormat. In some implementations, the format may be presented electronically, such as via a web page and allowing consistent comparisons across projects with normalized data that would be impossible without the consistent translation of data mentioned above.

The data processing of operation 112, along with operation 110, may be performed by suitable processing software. In some embodiments, the processing may be performed in a custom application. Processing, as suggested above, may include calculating a cost estimate from the materials quantity. Furthermore, processing may include expanding on identified items using relevant information, such as building codes, industry practices, etc. Finally, in some embodiments, machine learning (ML) algorithms may be employed to improve the classification process. In still other embodiments, the ML system may comprise part or all of the algorithms used for extraction, analysis, de-duplication, and/or tagging. In some such embodiments, the ML system may comprise all or part of a rules engine.

While the foregoing method 100 is directed to a building or other structure, it should be understood that the method could be applied to other construction projects, e.g. ships, planes, or even other physical goods such as cars, motorcycles, electronics, etc. Furthermore, while example software is mentioned above for supporting method 100, in other implementations the functionality providing method 100 may be combined into a single dedicated software program, such as a standalone application. The application or applications may accept a 3D model, focused or possibly with surrounding context, and return an estimate as discussed above in operation 110. Other software combinations or platforms may be utilized that can support the operations of method 100.

FIG. 2 is an example process flow 200 illustrating the progression from a 3D model to an analysis report that may result from a method such as method 100. Process flow 200 may be carried out by a software application, such as a software application implementing part or all of method 100, described above with respect to FIG. 1. Process flow 200 begins with a raw 3D view 202, which includes a building of interest along with surrounding context. The raw 3D view 202, in the example flow, is depicted as may be as viewed in a BIM software package. It should be understood that, in various embodiments, the actual information provided for processing would not necessarily be graphical in nature, but rather would be the underlying information useable by a model viewer for generating a 3D view. As can be seen, the surrounding context may include other buildings, streets, and landscaping, along with other possible structures. View 202 is stripped down to create a focused architectural model 204. As can be seen, model 204 includes only a rendering of the building of interest, with all surrounding context removed.

As discussed above with respect to architectural model data, the example model 204 can be broken down into a plurality of constituent components 206, such as walls, windows, roofs, etc. These constituent components 206 may be extracted from the underlying information that is used to create the model 204, as discussed above and with respect to method 100. The constituent components 206 are then processed by the software platform implementing method 100 to normalize the component data using as a rules engine like those discussed in operation 104 above. The software platform may use the same or a second, different rules engine, which may include one or more classification algorithms (which may include one or more templates) and/or may load one or more sets of data from the example model 204, for processing a list of the constituent components 206 into a format for extraction, such as one or more of the formats discussed above with respect to operation 110 of method 100. The data is then processed and made available for viewing or export, which may be to one or several different formats.

The result of the extraction and tagging process may be a spreadsheet 208, which may be represented in a file format native to a spreadsheet program, a CSV format file, or another suitable format. The spreadsheet 208 may then be processed to generate a report 210, which provides an analysis of construction materials quantities and/or cost estimates for the building identified in model 204. The report 210 may be presented or otherwise made available in a number of different ways. In some embodiments, the report 210 may be viewable online, such as through the software platform. Alternatively or additionally, the report 210 may be viewable through a standalone software platform or application. Still further, in some embodiments the report 210 may be made available in an appropriate file format that may be useable for further processing. It should be understood that exporting to an external format may or may not be necessary, depending upon the functionality of the software platform and the intended use for the information.

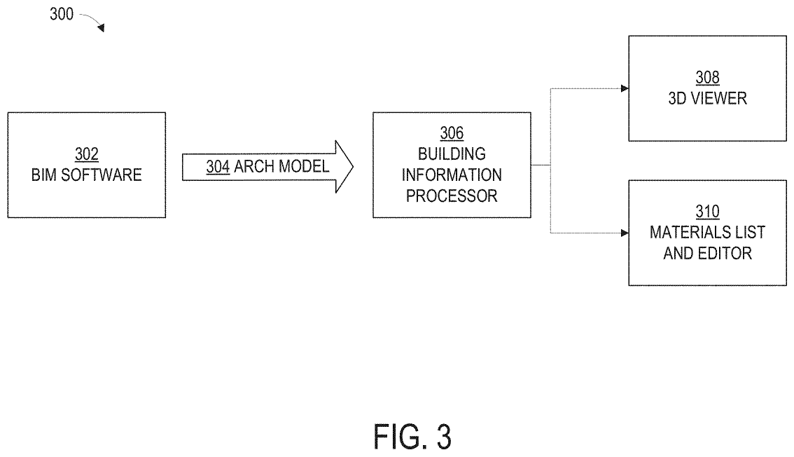

FIG. 3 is a block diagram of an example system 300 which may be used to implement method 100 and/or aspects of process flow 200. System 300 includes BIM software 302, which may be provided by a third party vendor in some embodiments. BIM software 302 may be a commercially available BIM software application, such as Autodesk's Revit software, or another BIM package or CAD program suitable for creation of building models and/or plans. The BIM software 302, in embodiments, is capable of exporting or configured to export an architectural model 304, such as a 2D or 3D model of a building being designed. The architectural model 304, in embodiments, includes component information about the designed building, such as building materials specifications and dimensions, and may include other relevant information such as structural aspects, finish aspects, trade-relevant information such as electrical, plumbing, and/or HVAC specifications, and/or any other relevant building information that may be entered into the BIM software 302.

The architectural model 304 is provided to a building information processor 306. The building information processor 306, in embodiments, implements at least part of method 100 (FIG. 1), such as some or all of operations 104, 106, and/or 108. Additional operations of method 100 may also be performed by building information processor 306. The building information processor 306 may be implemented as software, hardware, or a combination of both. In some embodiments, building information processor 306 may further implement some or all of operation 110, and may obviate the need for the export of operation 108 to be performed, viz. building information processor 306 may incorporate functionality that is carried out by an external program such as a spreadsheet in other embodiments. Furthermore, in still other embodiments, building information processor 306 may carry out some or all of operation 112, exporting the data extracted and processed from the architectural model 304 into a format suitable for presentation or such other further processing as is needed or desired.

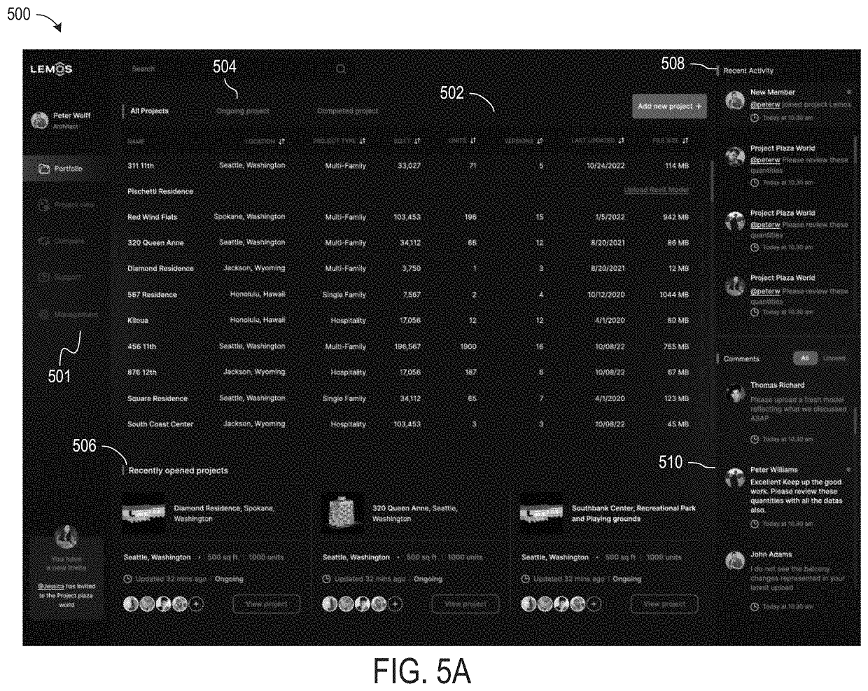

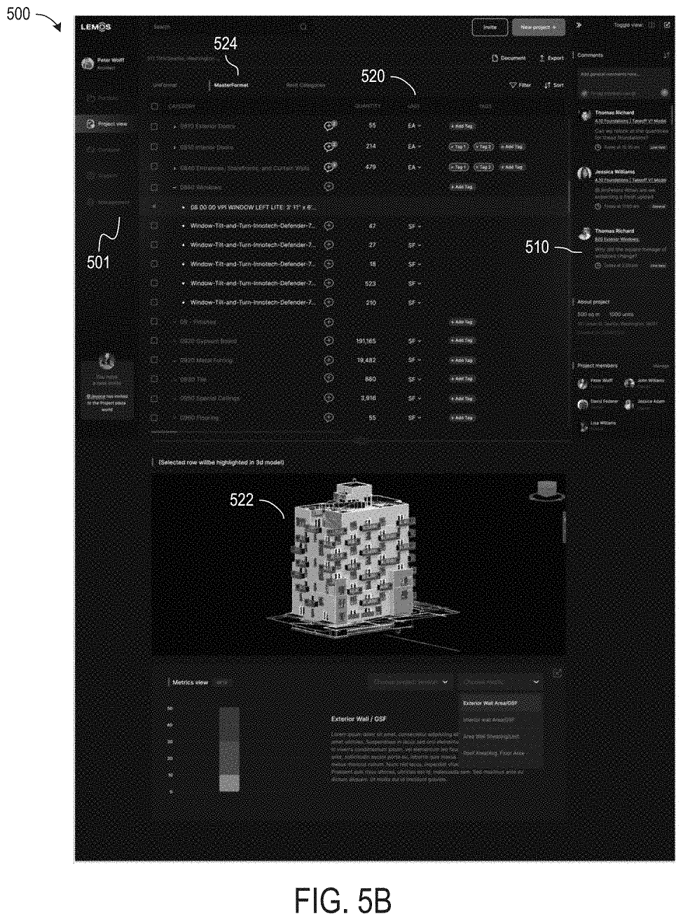

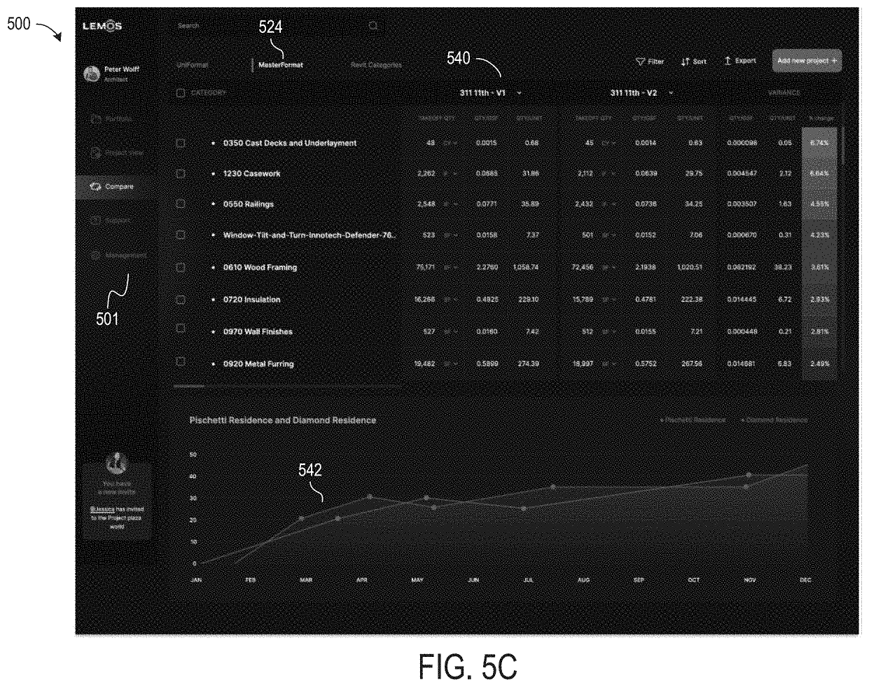

System 300 further may include a 3D viewer 308 and materials list and editor 310. 3D viewer 308 and materials list and editor 310 may be implemented in part as components of a graphical interface supported by system 300. 3D viewer 308 may accept architectural model 304 (or a suitable derivative thereof), and provide a visual recreation of the model, similar to how the model may have appeared in the BIM software 302. The materials list and editor 310 may provide a visual list of the various building components extracted via method 100, that a user of system 300 may view and, depending on the specifics of a given implementation, with which the user may interact. The 3D viewer 308 and materials list and editor 310 will be described in greater detail below with reference to FIGS. 5A to 5C.

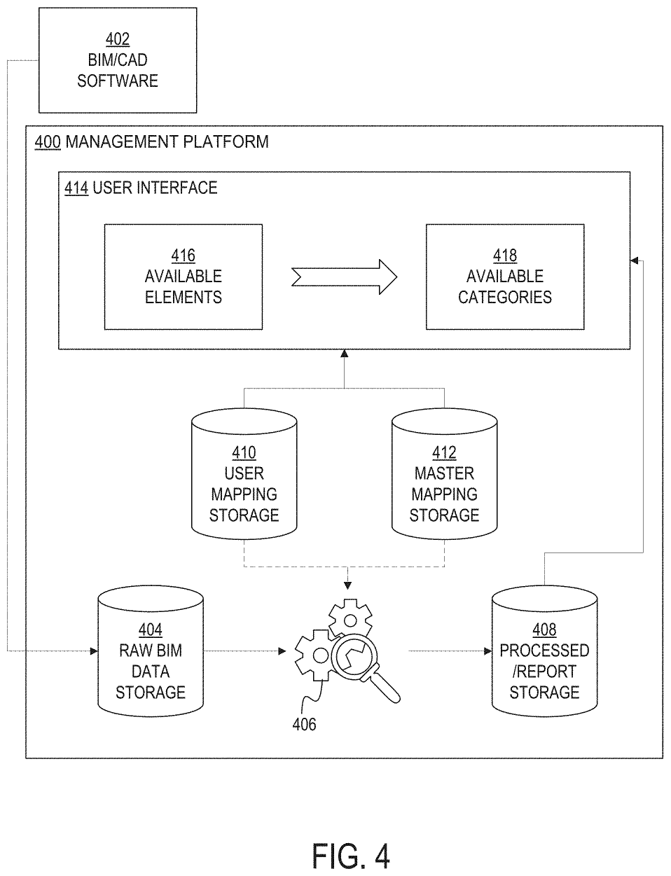

FIG. 4 depicts a flow diagram of an example import and rules engine that may be used in conjunction with method 100 (FIG. 1). The import and rules engine is part of management platform 400, which may implement some or all of process flow 200 (FIG. 2) and some or all of system 300 (FIG. 3), in addition to some or all operations of method 100. In embodiments, management platform 400 receives data, such as an architectural model and/or data derived from an architectural model, from BIM or CAD software 402. BIM or CAD software 402 is the same as the BIM software 302 described above with respect to system 300. Management platform 400 may be implemented as software, hardware, or a combination of both.

Data provided to management platform 400 by BIM or CAD software 402, in embodiments, is directed to raw BIM data storage 404. Raw BIM data storage 404 may be any suitable data storage, such as a memory or storage attached to a computer device 1500. The data storage 404 may, in embodiments, act as a persistent repository for one or more sets of data obtained from the BIM or CAD software 402. Depending upon the specifics of a given implementation of management platform 400, the data may encompass multiple different architectural models, different iterations of one or more architectural models, and/or data from a single architectural model. For example, the data stored in data storage 404 may include multiple different projects and/or historic versions of a given architectural model, to facilitate comparisons between different projects and/or across historic versions and revisions of a given architectural model, e.g., a user may be able to compare two different projects, previous versions of a given architectural model with a current version or other previous version, a previous version of one architectural model with a previous or current version of another architectural model, etc., to gain insight into changes, impacts on cost, trends, etc. The raw BIM data storage 404 holds provided data for subsequent processing by rules engine 406.

Rules engine 406 retrieves or is otherwise provided with data from raw BIM data storage 404, and, in embodiments, processes the data in accordance with the operations of method 100 (FIG. 1), e.g. extracting out components (if not already extracted) and mapping to various categories in a standard format, determining quantities, etc. In some embodiments, ML may be employed as part or all of rules engine 406 to increase the efficiency and accuracy of these mappings. The results of processing by rules engine 406 are placed into processed/report storage 408. Processed/report storage 408 may be similar in nature to raw BIM data storage 404, described immediately above.

The processed/report storage 408 may provide data to a user interface 414 for interaction by a user of management platform 400. The processed data from rules engine 406 may be used to provide a list of components and quantities, as well as a 3D model view, to a user via user interface 414. User interface 414 is in communication with additional storage, user mapping storage 410 and master mapping storage 412. This additional storage may be of a same or similar nature to raw BIM data storage 404 and/or processed/report storage 408.

User mapping storage 410 can be used to remember specific categorizations a user of user interface 414 may supply for associating components from an architectural model with various categories that are available from an industry-standard or other defined format, into which the processed data may be exported. Similarly, master mapping storage 412 may supply default or otherwise predetermined mappings between components with the various format categories. In embodiments, changes or alterations to mappings provided by master mapping storage 412 may be stored into user mapping storage 410, along with new mappings for components that may not have a specific default or predetermined mapping available in master mapping storage 412. The user mapping storage 410 and/or master mapping storage 412 may include mappings for multiple different industry standard and/or user defined formats. Furthermore, user mapping storage 410 may store mappings tied to specific users. In some embodiments, the stored mappings may vary between architectural models, e.g. a user may map a given component of a first architectural model to a first category, while the same component may map to a second category for a second architectural model.

User interface 414 may include a first interface component for listing available elements 416, and a second interface component for listing available categories 418. The available elements 416 may list all or some of the components of a given architectural model, while the available categories 418 may list all or some categories of a given industry standard (or user defined) format. Depending on the mode or configuration of a given embodiment of user interface 414, the listed available elements 416 and/or available categories 418 may either be all components/categories in the respective model or format, or only unassigned components/categories.

For example, rules engine 406 may perform an initial mapping of various components from raw BIM data storage 404 to various categories from a predetermined threshold, according to the mappings found in master mapping storage 412. In embodiments, mapping in user mapping storage 410, if present and applicable, may also be applied. Following processing by rules engine 406, there may be components for which no mappings exist and/or the rules engine 406 could not determine. These “unclassified” components may subsequently be presented to a user via the available elements 416. Similarly, available categories 416 may present to the user either only those categories that are not yet assigned, such as when the rules for a particular format only allow a one to one mapping of component to category, or present all possible categories, such as when the rules for the format allow mapping of multiple components to a single category. Once a user uses the user interface 414 to map the orphaned components, the new mappings may be stored into user mapping storage 410. In embodiments, this storage may then be utilized by the ML algorithms.

In embodiments, the user interface 414 may further allow an administrator of management platform 400 to establish, delete, or otherwise modify the mappings found in master mapping storage 412. In such a configuration, the available elements 416 may indicate generic or possible components that are supported by management platform 400, while indicating any existing mappings to available categories 418. An administrator may then create new mappings, edit existing mappings, and/or deleted existing mappings, and save such changes back to master mapping storage 412. Similarly, an administrator may view the mappings resulting from processing by rules engine 406 for a given architectural model and make any desired changes.

As discussed above, in some further embodiments rules engine 406 may incorporate ML techniques, such as classifiers based on an artificial neural network (ANN) or another suitable machine learning process. These ML techniques may accept as input new mappings of uncategorized components and/or modifications to mappings provided through user interface 414, which can train the ANN or ML process to anticipate possible mappings for future uncategorized components that may be encountered. These anticipated mappings may then be supplied to a user as suggested mappings via user interface 414. Depending on the specifics of a given embodiment, the suggested mappings may be implemented and the user notified of such mappings to allow possible editing, or may simply be suggested to a user, with the user deciding whether to accept the suggestion. The user interaction with the suggested mappings and/or edits to anticipated mappings may also be fed back into the ANN or ML process to further refine subsequent suggestions. If suggested mappings are accepted, these mappings may be stored back into either user mapping storage 410 or master mapping storage 412, which may depend on whether the user is an administrator.

FIGS. 5A-5C depict various interface screens for a user interface 500, which may be an implementation of user interface 414 for management system 400 (FIG. 4). It should be understood that user interface 500 is only one possible embodiments. Other embodiments may implement an interface with a different appearance and/or different types of available data and controls, depending upon the needs of a given implementation. The user interface 500, in embodiments, may be customizable by a user or administrator depending upon the needs of an implementing organization. As can be seen in FIGS. 5A to 5C, in embodiments the system can support multiple users, with multiple users potentially being able to interact in various ways with a single model as well as each other, e.g. sharing comments, revisions, etc.

FIG. 5A depicts an initial screen with a list of available projects 502 that have been loaded into the system, such architectural models that may be loaded into raw BIM data storage 404 (FIG. 4). The initial screen may be selected from a list of interface pages 501; as shown, the initial screen is a Portfolio view. The various projects may be listed with relevant data such as location, project type, square footage, number of units, available or stored versions of the project, date of last updating, and project size. More, fewer, or different data categories may be available for display, depending upon the specifics of a given implementation. Also visible is a set of tabs 504 for selecting the view of the available projects 502. In the depicted embodiment, tabs 504 provide for switching between viewing all projects, ongoing projects, or completed projects. The user interface 500 of FIG. 5A further may include a section for recently opened projects 506, to allow quick access to the most recently viewed or access projects. The user interface 500 may further support cross-user interaction, such as a recent activity listing 508, which may display the activities of various users of the system and/or messages, and a comments listing 510, where users may embed or otherwise link comments to a specific project.

In FIG. 5B, the Project view is selected from the interface pages 501, bringing up a second screen, in embodiments. Alternatively, a user may select a specific project from the Portfolio view of FIG. 5A, which may automatically toggle the Project view screen. The Project view includes a listing 520 of all components of a selected project. Each component listing may include information such as quantity and unit type, as well as any tags, if supported by a given embodiment. A 3D viewer 522 may be provided below the listing 520 of components, to provide a 3D view of the selected project architectural model. In embodiments, selecting of a component from listing 520 may cause all instances of the selected component to be displayed on the model in 3D viewer 522. The 3D viewer 522 may further provide additional information about a selected component, such as component metrics, component areas, etc. Also visible is a set of tabs 524 for selecting the desired output format, such as MasterFormat or UniFormat, discussed above, along with the comments listing 510.

FIG. 5C illustrates a third screen that may be selected from interface pages 501, the Compare view. In the Compare view, a list of available versions 540 of a given project may be provided, the different versions corresponding to different iterations of a given project. The project may have been re-uploaded into the system from BIM software as the architectural model was refined, with each re-uploaded creating a new version. Alternatively or additionally, a user may create a new version in the user interface 500 intentionally and/or by modifying project aspects through the interface 500. The Compare view can allow the user to view and compare differences between the same components and/or same categories of components across versions, to determine changes in cost, size, quantities, etc., as well as the omission or addition of existing or new components. Details of specific variances may be provided. Further, a user may be able to select desired versions to compare. Depending upon the specifics of a given embodiment, a user further may be able to compare two different projects against each other, which is made possible because of the consistent translation of data into standard classification systems where typically classifications have varied widely. Also visible in the Compare view is a data visualization tool 542, shown as a trend chart, that allows the changes over time for a given project or set of projects to be visualized. Finally, as with the screen in FIG. 5B, also visible is a set of tabs 524 for selecting the desired output format, such as MasterFormat or UniFormat, discussed above, along with the comments listing 510.

FIG. 6 illustrates an example computer device 1500 that may be employed by the apparatuses and/or methods described herein, in accordance with various embodiments. As shown, computer device 1500 may include a number of components, such as one or more processor(s) 1504 (one shown) and at least one communication chip 1506. In various embodiments, one or more processor(s) 1504 each may include one or more processor cores. In various embodiments, the one or more processor(s) 1504 may include hardware accelerators to complement the one or more processor cores. In various embodiments, the at least one communication chip 1506 may be physically and electrically coupled to the one or more processor(s) 1504. In further implementations, the communication chip 1506 may be part of the one or more processor(s) 1504. In various embodiments, computer device 1500 may include printed circuit board (PCB) 1502. For these embodiments, the one or more processor(s) 1504 and communication chip 1506 may be disposed thereon. In alternate embodiments, the various components may be coupled without the employment of PCB 1502.

Depending on its applications, computer device 1500 may include other components that may be physically and electrically coupled to the PCB 1502. These other components may include, but are not limited to, memory controller 1526, volatile memory (e.g., dynamic random access memory (DRAM) 1520), non-volatile memory such as read only memory (ROM) 1524, flash memory 1522, storage device 1554 (e.g., a hard-disk drive (HDD)), an I/O controller 1541, a digital signal processor (not shown), a crypto processor (not shown), a graphics processor 1530, one or more antennae 1528, a display, a touch screen display 1532, a touch screen controller 1546, a battery 1536, an audio codec (not shown), a video codec (not shown), a global positioning system (GPS) device 1540, a compass 1542, an accelerometer (not shown), a gyroscope (not shown), a depth sensor 1548, a speaker 1550, a camera 1552, and a mass storage device (such as hard disk drive, a solid state drive, compact disk (CD), digital versatile disk (DVD)) (not shown), and so forth.

In some embodiments, the one or more processor(s) 1504, flash memory 1522, and/or storage device 1554 may include associated firmware (not shown) storing programming instructions configured to enable computer device 1500, in response to execution of the programming instructions by one or more processor(s) 1504, to practice all or selected aspects of method 100 and process flow 200 described herein. In various embodiments, these aspects may additionally or alternatively be implemented using hardware separate from the one or more processor(s) 1504, flash memory 1522, or storage device 1554.

The communication chips 1506 may enable wired and/or wireless communications for the transfer of data to and from the computer device 1500. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication chip 1506 may implement any of a number of wireless standards or protocols, including but not limited to IEEE 802.20, Long Term Evolution (LTE), LTE Advanced (LTE-A), General Packet Radio Service (GPRS), Evolution Data Optimized (Ev-DO), Evolved High Speed Packet Access (HSPA+), Evolved High Speed Downlink Packet Access (HSDPA+), Evolved High Speed Uplink Packet Access (HSUPA+), Global System for Mobile Communications (GSM), Enhanced Data rates for GSM Evolution (EDGE), Code Division Multiple Access (CDMA), Time Division Multiple Access (TDMA), Digital Enhanced Cordless Telecommunications (DECT), Worldwide Interoperability for Microwave Access (WiMAX), Bluetooth, derivatives thereof, as well as any other wireless protocols that are designated as 3G, 4G, 5G, and beyond. The computer device 1500 may include a plurality of communication chips 1506. For instance, a first communication chip 1506 may be dedicated to shorter range wireless communications such as Wi-Fi and Bluetooth, and a second communication chip 1506 may be dedicated to longer range wireless communications such as GPS, EDGE, GPRS, CDMA, WiMAX, LTE, Ev-DO, and others.

In various implementations, the computer device 1500 may be a laptop, a netbook, a notebook, an ultrabook, a smartphone, a computer tablet, a personal digital assistant (PDA), a desktop computer, smart glasses, or a server. In further implementations, the computer device 1500 may be any other electronic device that processes data.

As will be appreciated by one skilled in the art, the present disclosure may be embodied as methods or computer program products. Accordingly, the present disclosure, in addition to being embodied in hardware as earlier described, may take the form of an entirely software embodiment (including firmware, resident software, micro-code, etc.) or an embodiment combining software and hardware aspects that may all generally be referred to as a “circuit,” “module” or “system.” Furthermore, the present disclosure may take the form of a computer program product embodied in any tangible or non-transitory medium of expression having computer-usable program code embodied in the medium.

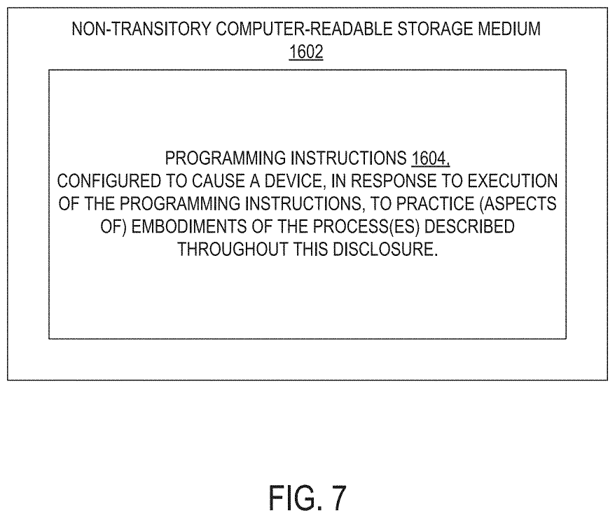

FIG. 7 illustrates an example computer-readable non-transitory storage medium that may be suitable for use to store instructions that cause an apparatus, in response to execution of the instructions by the apparatus, to practice selected aspects of the present disclosure. As shown, non-transitory computer-readable storage medium 1602 may include a number of programming instructions 1604. Programming instructions 1604 may be configured to enable a device, e.g., computer 1500, in response to execution of the programming instructions, to implement (aspects of) method 100 or process flow 200 described above. In alternate embodiments, programming instructions 1604 may be disposed on multiple computer-readable non-transitory storage media 1602 instead. In still other embodiments, programming instructions 1604 may be disposed on computer-readable transitory storage media 1602, such as, signals.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non- exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present disclosure may be written in any combination of one or more programming languages, including an object oriented programming language such as Java, Smalltalk, C++ or the like and conventional procedural programming languages, such as the “C” programming language or similar programming languages, or other languages such as JavaScript and Python. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

It will be apparent to those skilled in the art that various modifications and variations can be made in the disclosed embodiments of the disclosed device and associated methods without departing from the spirit or scope of the disclosure. Thus, it is intended that the present disclosure covers the modifications and variations of the embodiments disclosed above provided that the modifications and variations come within the scope of any claims and their equivalents.

What is claimed is:

1. A method, comprising:
receiving an architectural model;
processing the architectural model to determine relevant components and normalize component data;
extracting the component data of the architectural model;
translating the component data into quantity data; and
preparing, from the translated quantity data, a materials quantity for the architectural model.

2. The method of claim 1, wherein receiving the architectural model comprises receiving an architectural model that is isolated from surrounding context.

3. The method of claim 1, wherein processing the architectural model to determine relevant components further comprises tagging components in order to avoid double counting, and prepare them for inclusion in a standard report format.

4. The method of claim 1, wherein processing and extracting are performed at least in part in a building information and modeling software.

5. The method of claim 1, wherein exporting the relevant components comprises exporting the relevant components to a known standard file format.

6. The method of claim 1, further comprising providing the architectural model to a 3D viewer of an interface for presentation.

7. The method of claim 6, further comprising indicating, on the 3D viewer, the location of all instances of a relevant component when selected in the interface.

8. A non-transitory computer-readable medium (CRM) comprising instructions that, when executed by a processor of an apparatus, cause the apparatus to:
receive an architectural model;
process the architectural model to determine relevant components and normalize component data;
extract the component data of the architectural model;
translate the component data into quantity data; and
prepare, from the translated quantity data, a materials quantity for the architectural model.

9. The CRM of claim 8, wherein the architectural model comprises an architectural model that is isolated from surrounding context.

10. The CRM of claim 8, wherein the instructions are to further cause the apparatus to tag components in order to avoid double counting, and prepare them for inclusion in a standard report format.

11. The CRM of claim 8, wherein the instructions comprise part of a building information and modeling software.

12. The CRM of claim 8, wherein the instructions are to further cause the apparatus to export the relevant components to a known standard file format.

13. The CRM of claim 8, wherein the instructions are to further cause the apparatus to provide the architectural model to a 3D viewer of an interface for presentation.

14. The CRM of claim 13, wherein the instructions are to further cause the apparatus to indicate, on the 3D viewer, the location of all instances of a relevant component when selected in the interface.

15. A system, comprising:
a building information management software;
a building information processing tool; and
a building information interface,
wherein the building information processing tool is to:
receive an architectural model from the building information management software;
process the architectural model to determine relevant components and normalize component data;
extract the component data of the architectural model;
translate the component data into quantity data; and
prepare, from the translated quantity data, a materials quantity for the architectural model.

16. The system of claim 15, wherein the architectural model comprises an architectural model that is isolated from surrounding context.

17. The system of claim 15, wherein the instructions are to further cause the apparatus to tag components in order to avoid double counting, and prepare them for inclusion in a standard report format.

18. The system of claim 15, wherein the building information processing tool is to export the relevant components to a known standard file format.

19. The system of claim 15, wherein the building information interface comprises a 3D viewer, and the building information processing tool is to provide the architectural model to the building information interface for presentation on the 3D viewer.

20. The system of claim 19, wherein the building information interface is to indicate, on the 3D viewer, the location of all instances of a relevant component when selected in the building information interface.

21. The system of claim 15, wherein the building information processing tool is to further store one or more previous versions of the architectural model, and to allow time based analysis of one or more of the versions of the architectural model.

22. The system of claim 15, wherein the building information interface supports interaction between multiple users.

23. The system of claim 15, wherein the building information processing tool is to further store a plurality of different architectural models, and to allow comparison between two or more of the plurality of different architectural models.
